(19) United States
(12) Patent Application Publication
(10) Pub. No.: US 2010/0026593 A1
(43) Pub. Date: Feb. 4, 2010

(54) Broadband antenna and an electronic device having the broadband antenna

(75) Inventors: Li-Min Chang, Taipei Hsien (TW); Wei-Shan Chang, Taipei Hsien (TW); Shuen-Sheng Chen, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/453,089

(22) Filed: Apr. 29, 2009

(30) Foreign Application Priority Data
Aug. 4, 2008 (TW) 097129566

(51) Int. Cl. H01Q 9/04; H01Q 1/24; H01Q 5/00

(52) U.S. Cl. 343/702; 343/700 MS

(57) ABSTRACT

A broadband antenna for wireless signal transmission of an electronic device is disclosed. The broadband antenna has a radiation area, a ground area, a feeding point, a first tuning bar, and a second tuning bar. The feeding point is disposed on the radiation area and is used for feeding a signal. The first tuning bar is used for adjusting a high frequency bandwidth of the broadband antenna. The second tuning bar is used for adjusting a low frequency bandwidth of the broadband antenna. The length of the first tuning bar is less than the length of the second tuning bar.

### BACKGROUND OF THE INVENTION

1. Field of the Invention

The present invention relates to a broadband antenna and, more particularly, to a broadband antenna with a tuning bar.

2. Description of the Related Art

With developments in wireless communications technologies, many electronic devices in the market, such as notebook computers, have become lighter and smaller. In particular, users require not only the functionalities of the notebook computers; they also require the notebook computers to be lightweight and slim. Therefore, a traditional antenna cannot be disposed in the structural space of the notebook computers.

The prior art technology discloses a traditional monopole antenna. Please refer to FIG. 1A. FIG. 1A is a schematic drawing a monopole antenna of the prior art. The prior art antenna 90 is a traditional monopole antenna. The prior art antenna 90 has a radiating element 91, a grounding element 92 and a feeding point F. The radiating element 91 is used for radiating a wireless signal. The grounding element 92 is used for grounding the antenna 90. The grounding element 92 has a wide metal plane or connects to a metal part of an electronic device to increase the grounding area. The antenna 90 transmits an electrical signal via the feeding point F.

Please refer to FIG. 1B. FIG. 1B shows the dB values at different frequencies of the prior art antenna 90 shown in FIG. 1A. As shown in FIG. 1B, if the antenna 90 can only be operated at less the −9.54 dB, the working frequency range of the antenna 90 is only from 2.92 GHz to 3.68 GHz approximately. Therefore, the bandwidth of the antenna 90 is only (3.68GHz-2.92GHz)=0.76 GHz. The center frequency of the antenna 90 is (3.68 GHz+2.92 GHz)/2=3.3 GHz, and the bandwidth percentage is only (0.76 GHz/3.3 GHz)=23.03%. Therefore the transmission bandwidth of the antenna 90 is limited. In addition, in order to transmit a 3.1 GHz signal, the height of the radiating element 91 of the antenna 90 must conform to the requirement of a quarter of the wavelength of the transmission signal, or about 20 mm. For this reason, the antenna 90 needs a large structural space.

Therefore, it is desirable to provide a broadband antenna to mitigate and/or obviate the aforementioned problems.

### SUMMARY OF THE INVENTION

A main objective of the present invention is to provide a broadband antenna with a tuning bar to increase the efficiency of the broadband transmission.

Another objective of the present invention is to provide an electronic device having the broadband antenna.

In order to achieve the abovementioned objective, the electronic device of the invention comprises a broadband antenna and a wireless transmission module. The broadband antenna electrically connects to the wireless transmission module. The broadband antenna comprises a radiation area, a ground area, a feeding point, a first tuning bar, and a second tuning bar. The feeding point is disposed on the radiation area to feed a signal. The ground area is used for grounding the broadband antenna. The first tuning bar is used for adjusting a high frequency bandwidth of the broadband antenna, and the second tuning bar is used for adjusting a low frequency bandwidth of the broadband antenna, wherein the length of the first tuning bar is less than the length of the second tuning bar.

Other objects, advantages, and novel features of the invention will become more apparent from the following detailed description when taken in conjunction with the accompanying drawings.

### BRIEF DESCRIPTION OF THE DRAWINGS

FIG. 1A is a schematic drawing of a prior art monopole antenna.

FIG. 1B shows the dB values at different frequencies of the prior art monopole antenna shown in FIG. 1A.

FIG. 2A is a schematic drawing of a broadband antenna of a first embodiment according to the invention.

FIG. 2B shows the dB values at different frequencies of the embodiment according to the invention shown in FIG. 2A.

FIG. 2C is a schematic drawing of a broadband antenna of a non-printed type embodiment according to the invention.

FIG. 3A is a schematic drawing of a broadband antenna of a second embodiment according to the invention.

FIG. 3B shows the dB values at different frequencies of the embodiment according to the invention shown in FIG. 3A.

FIG. 4A is a schematic drawing of a broadband antenna of a third embodiment according to the invention.

FIG. 4B shows the dB values at different frequencies of the embodiment according to the invention shown in FIG. 4A.

FIG. 5A is a schematic drawing of a broadband antenna of a fourth embodiment according to the invention.

FIG. 5B shows the dB values at different frequencies of the embodiment according to the invention shown in FIG. 5A.

FIG. 6A is a schematic drawing of a broadband antenna of a fifth embodiment according to the invention.

FIG. 6B shows the dB values at different frequencies of the embodiment according to the invention shown in FIG. 6A.

FIG. 7A is a schematic drawing of a broadband antenna of a sixth embodiment according to the invention.

FIG. 7B shows the dB values at different frequencies of the embodiment according to the invention shown in FIG. 7A.

FIG. 8A is a schematic drawing of a broadband antenna of a seventh embodiment according to the invention.

FIG. 8B is a schematic drawing of a broadband antenna of an eighth embodiment according to the invention.

FIG. 8C shows the dB values at different frequencies of the embodiments according to the invention presented in FIG. 8A and FIG. 8B.

FIG. 9A is a front schematic drawing of a broadband antenna of a ninth embodiment according to the invention.

FIG. 9B is a back schematic drawing of a broadband antenna of the ninth embodiment according to the invention.

FIG. 9C shows the dB values at different frequencies of the embodiments according to the invention shown in FIG. 9A and FIG. 9B.

FIG. 10A is a schematic drawing of a broadband antenna of a tenth embodiment according to the invention.

FIG. 10B shows the dB values at different frequencies of the embodiment according to the invention shown in FIG. 10A.

FIG. 11A is a schematic drawing of a broadband antenna of an eleventh embodiment according to the invention.

FIG. 11B is a schematic drawing of a broadband antenna of a twelfth embodiment according to the invention.

FIG. 11C is a schematic drawing of a broadband antenna of a thirteenth embodiment according to the invention.

FIG. 11D is a schematic drawing of a broadband antenna of a fourteenth embodiment according to the invention

FIG. 12 is a functional block drawing of an electronic device according to an embodiment of the invention.

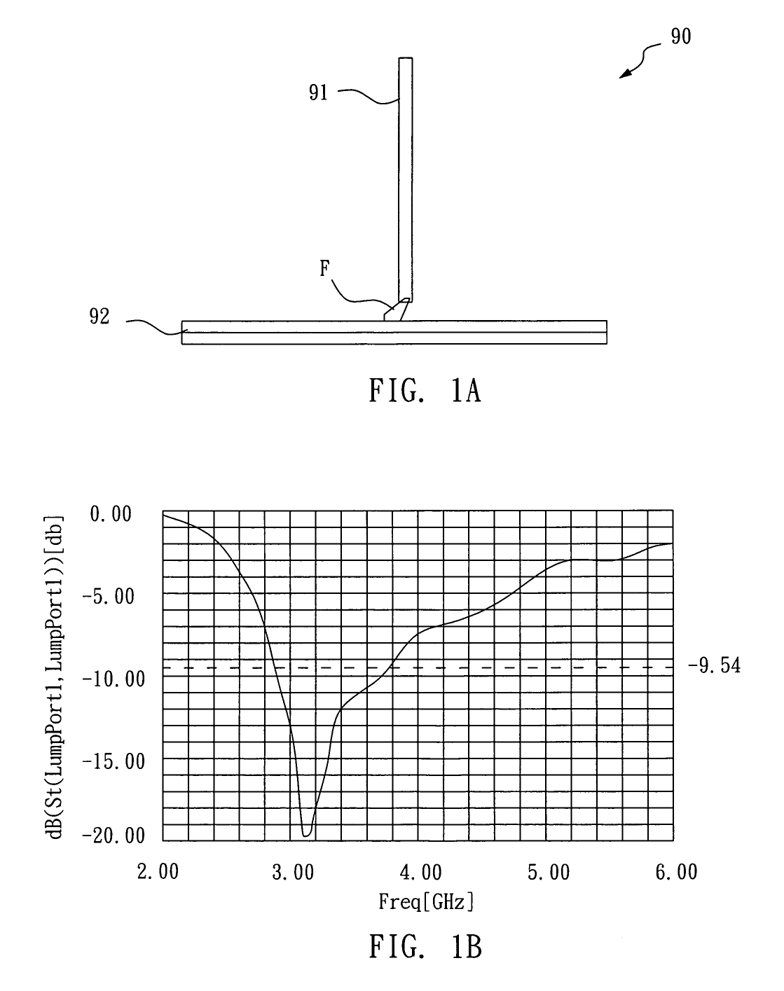

### DETAILED DESCRIPTION OF THE PREFERRED EMBODIMENT

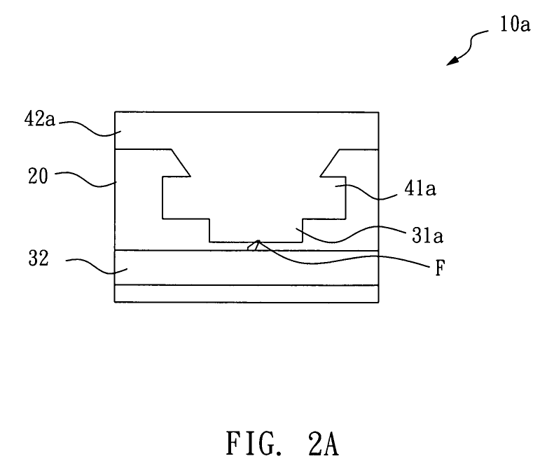

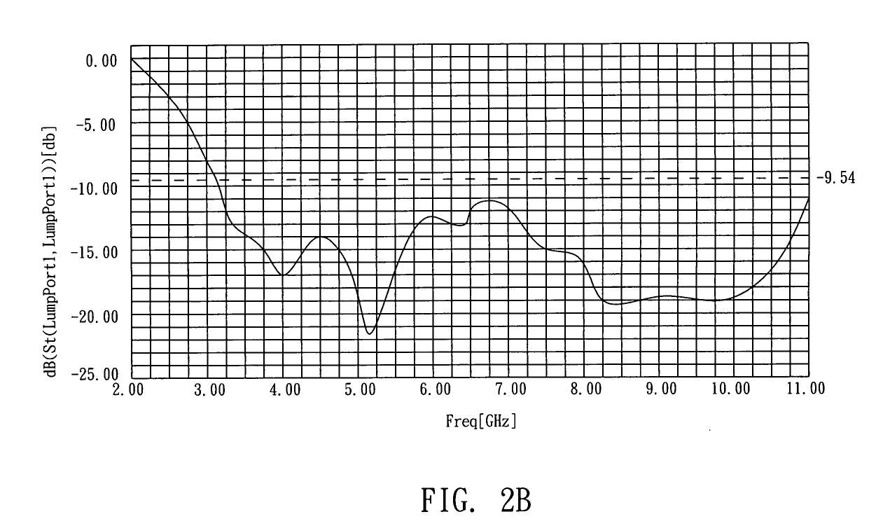

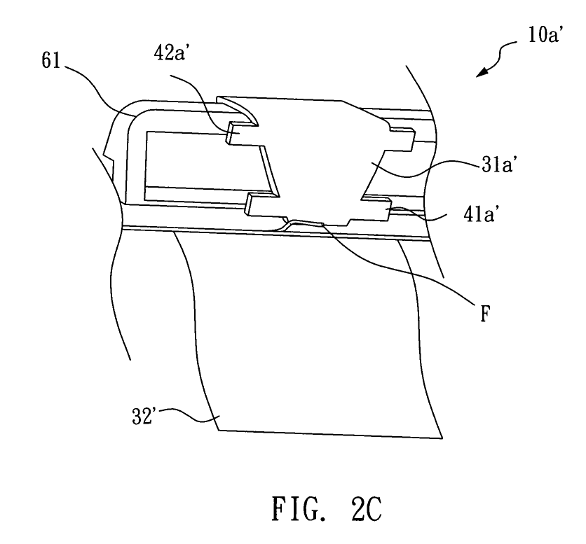

Please refer to FIG. 2A. FIG. 2A is a schematic drawing of a broadband antenna according to a first embodiment according to the invention.

The broadband antenna 10a comprises a base board 20, a radiation area 31a, a ground area 32, a first tuning bar 41a, a second tuning bar 42a, and a feeding point F. The base board 20 is a printed circuit board, a plastic board, or a fiberglass board; but the invention is not limited to the above-mentioned devices. The radiation area 31a, the ground area 32, the first tuning bar 41a, and the second tuning bar 42a are printed on the base board 20. The radiation area 31a is used for transmitting wireless communication signals. In the first embodiment, the radiation area 31a has a width that varies according to the gradient of the edges of the radiation area 31a. As shown in FIG. 2A, the width of the radiation area 31a increases gradually along the vertical axis. The broadband antenna 10a can transmit a broadband signal with the shape of the radiation area 31a. The ground area 32 is used for grounding the broadband antenna 10a. The ground area 32 has superior grounding effect by having a wide metal plane or connecting to a metal part of an electronic device, but the invention is not limited to the connection aforementioned.

In the first embodiment, the first tuning bar 41a and the second tuning bar 42a are disposed on the same plane of the base board 20 with the radiation area 31a, and extend from the range of the radiation area 31a; wherein the length of the first tuning bar 41a is less than the length of the second tuning bar 42a. The first tuning bar 41a and the second tuning bar 42a are parallel to each other substantially; but the invention is not limited to that. The first tuning bar 41a is used for adjusting the high frequency of the broadband antenna 10a, and the second tuning bar 42a is used for adjusting the low frequency of the broadband antenna 10a. The feeding point F is disposed on the radiation area 31a. The feeding point F and a feeding line (not shown) are electrically connected to each other and used for transmitting an electrical signal. The feeding line can be an RF cable or other type of transmission line; but the invention is not limited to that.

FIG. 2B shows the dB values at different frequencies of the embodiment according to the invention shown in FIG. 2A. As shown in FIG. 2B, if the antenna 90 can be operated at less the −9.54 dB, with the affect of the first tuning bar 41a and the second tuning bar 42a, the broadband antenna 10a is capable of transmitting signals with frequencies from 3.15 GHz to 11.13 GHz. Therefore, the bandwidth of the broadband antenna 10a is about (11.13 GHz-3.15 GHz)=7.98 GHz. The center frequency of the broadband antenna 10a is (3.15 GHz+11.13 GHz)/2=7.14 GHz, and the bandwidth percentage is (7.98 GHz/17.14 GHz)=112%. As compared to the antenna 90 of the prior art, the broadband antenna 10a has a broader bandwidth. The broadband antenna 10a has better transmission efficiency in low frequency or high frequency bandwidths. In addition, the height of the broadband antenna 10a is about 9 mm. As compared to the prior art antenna 90, the broadband antenna 10a occupies less structural space.

The broadband antenna according to the invention is not limited to the above. Please refer to FIG. 2C. FIG. 2C is a schematic drawing of a broadband antenna according to a non-printed type embodiment according to the invention.

In this embodiment, the broadband antenna 10a′ is a non-printed antenna. The broadband antenna 10a′ has no base board 20. A radiation area 31a′, a ground area 32′, a first tuning bar 41a′, and a second tuning bar 42a′ of the broadband antenna 10a′ are composed of a metal. The radiation area 31a′ can be fixed by a support 61. The radiation area 31a′ is used for feeding an electrical signal via the feeding point F. The broadband antenna 10a′ also has broadband transmission capabilities under this structure.

Please note that the shape of the radiation area 31a is not limited to the shape shown in FIG. 2A. Furthermore, the embodiments of the broadband antenna described later can be converted into the non-printed antenna and are capable of broadband transmission.

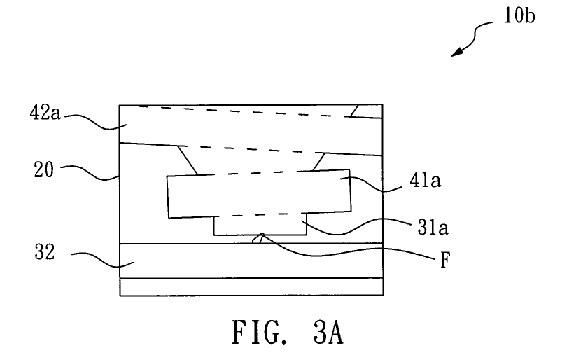

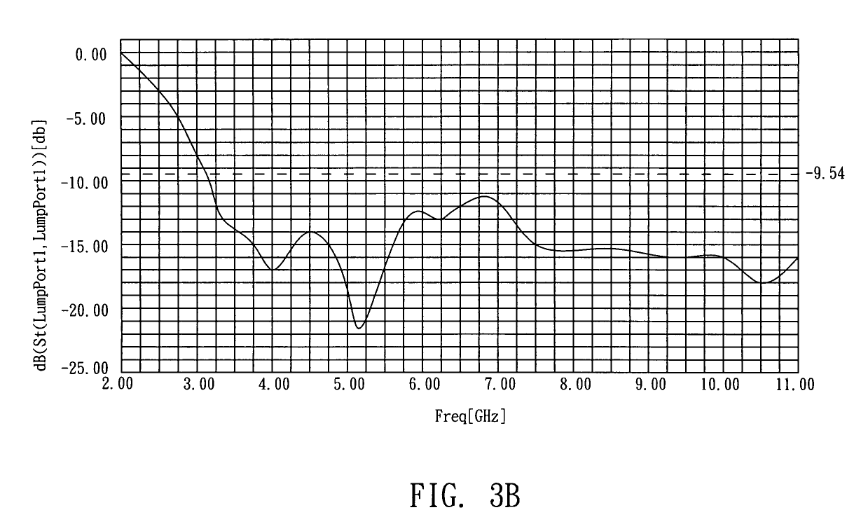

The relationship between the first tuning bar 41a and the second tuning bar 42a of the invention is not limited to the first embodiment. Please refer to FIG. 3A and FIG. 3B. FIG. 3A is a schematic drawing of a broadband antenna according to a second embodiment according to the invention. FIG. 3B shows the dB values at different frequencies of the embodiment according to the invention shown in FIG. 3A.

In the second embodiment according to the invention, the first tuning bar 41a of the broadband antenna 10b is not parallel to the second tuning bar 42a. The first tuning bar 41a and the second tuning bar 42a are disposed at a specific angle. As shown in FIG. 3B, the broadband antenna 10b of the second embodiment also has broadband transmission capabilities and is capable of adjusting the high or low frequency matching.

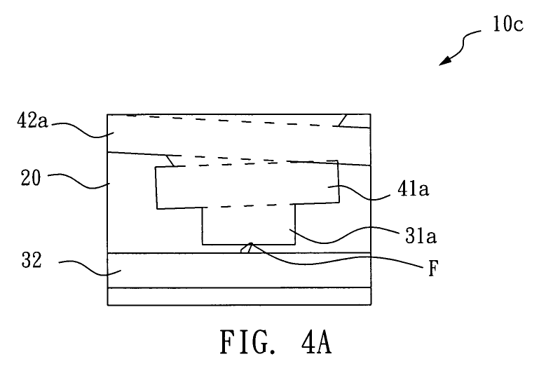

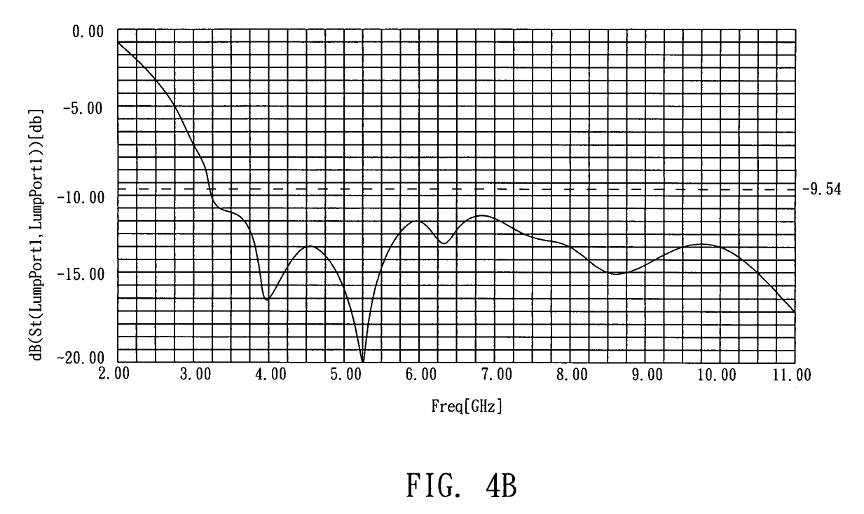

Please refer to FIG. 4A and FIG. 4B. FIG. 4A is a schematic drawing of a broadband antenna according to a third embodiment according to the invention. FIG. 4B shows the dB values at different frequencies of the embodiment according to the invention shown in FIG. 4A.

In the third embodiment according to the invention, the first tuning bar 41a and the second tuning bar 42a of the broadband antenna 10c are sloped and contact each other. The operation bandwidth of the broadband antenna 10c is shown in FIG. 4B. The broadband antenna 10c also has broadband transmission capabilities and is capable of adjusting the high or low frequency matching.

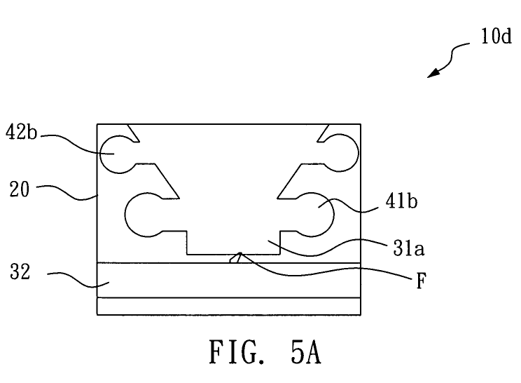

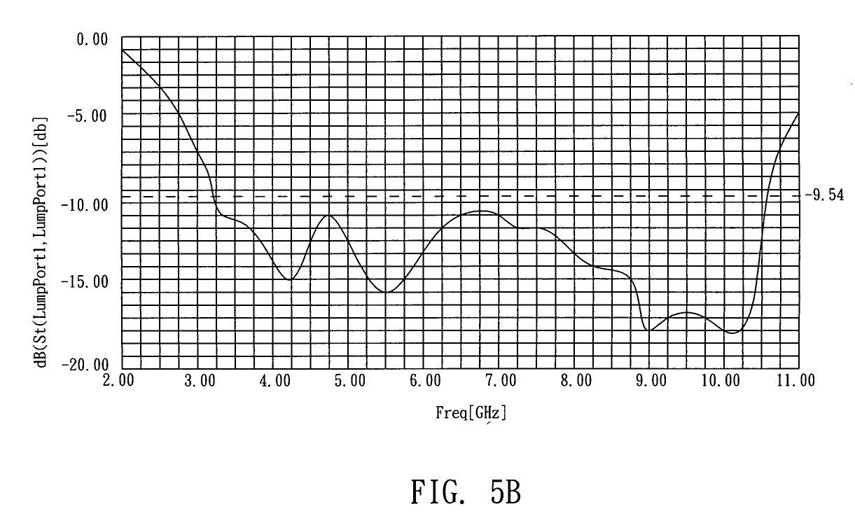

The shape of the first tuning bar is not limited to the aforementioned shape. Please refer to FIG. 5A and FIG. 5B. FIG. 5A is a schematic drawing of a broadband antenna according to a fourth embodiment according to the invention. FIG. 5B shows the dB values at different frequencies of the embodiment according to the invention shown in FIG. 5A.

In the fourth embodiment according to the invention, as shown in FIG. 5A, the ends of a first tuning bar 41b and a second tuning bar 42b of the broadband antenna 10d are rounded. As shown in FIG. 5B, the broadband antenna 10d also has broadband transmission capabilities according to the shape and is capable of adjusting the high or low frequency matching by adjustment of the first tuning bar 41b and the second tuning bar 42b.

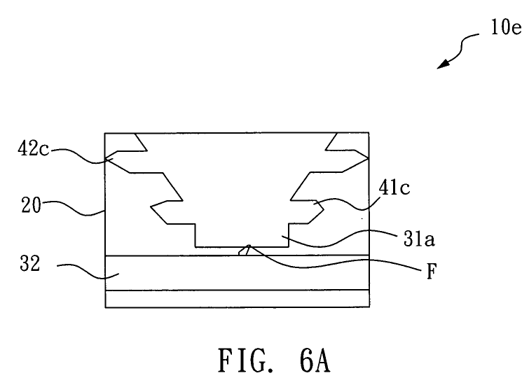

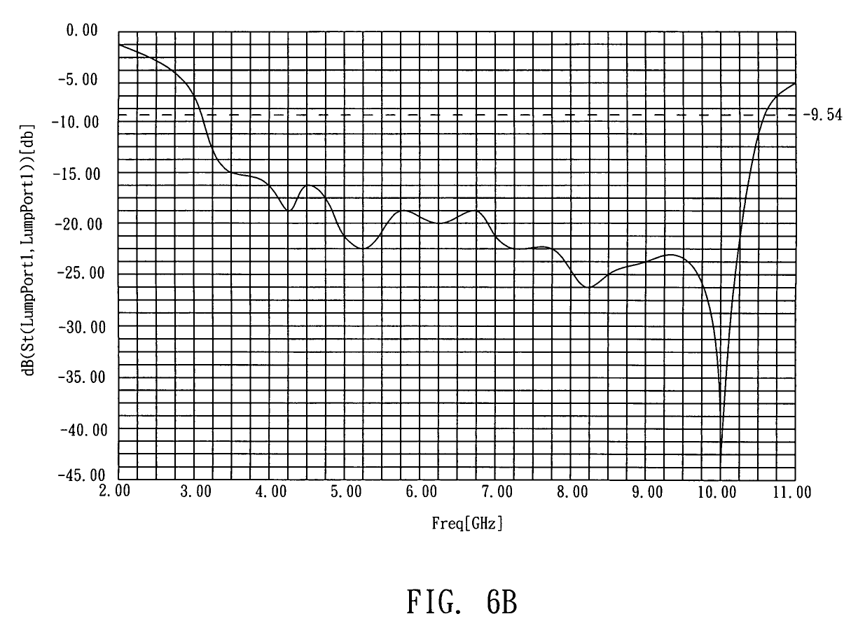

Please refer to FIG. 6A and FIG. 6B. FIG. 6A is a schematic drawing of a broadband antenna according to a fifth embodiment according to the invention. FIG. 6B shows the dB values at different frequencies of the embodiment according to the invention shown in FIG. 6A.

In the fifth embodiment according to the invention, as shown in FIG. 6A, the shape of a first tuning bar 41c and a second tuning bar 42c of the broadband antenna 10e have widths that vary according to the gradients of the edges of the first tuning bar 41c and the second tuning bar 42c, respectively. The ends of the first tuning bar 41c and the second tuning bar 42c are narrow, and the center portions of the first tuning bar 41c and the second tuning bar 42c are wide. As shown in FIG. 6B, the broadband antenna 10e also has broadband transmission capabilities according to the shapes of the first tuning bar 41c and the second tuning bar 42c and is capable of adjusting the high or low frequency matching by adjustment of the first tuning bar 41c and the second tuning bar 42c.

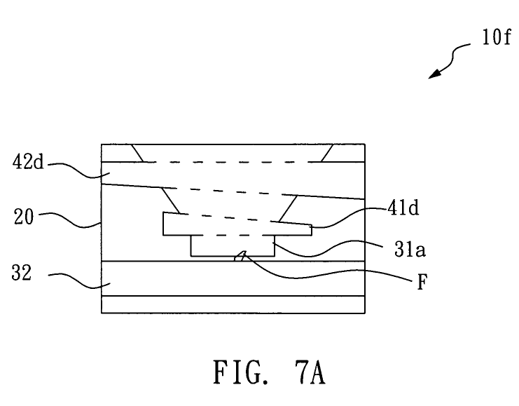

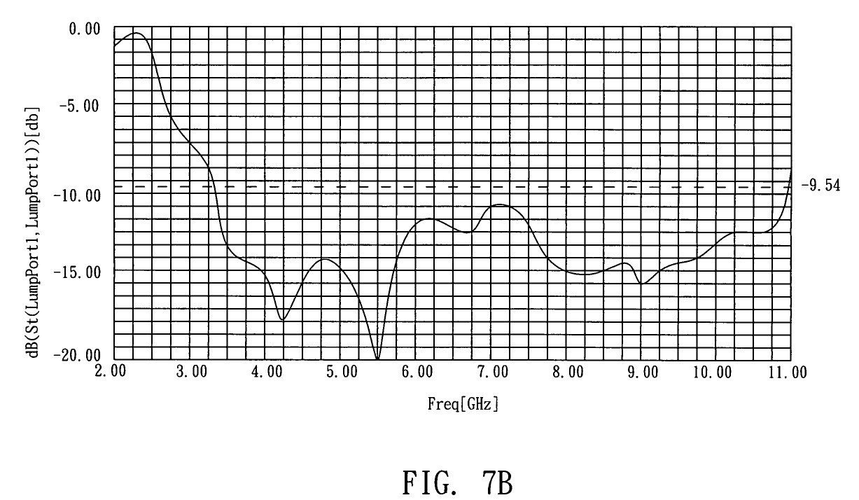

Please refer to FIG. 7A and FIG. 7B. FIG. 7A is a schematic drawing of a broadband antenna according to a sixth embodiment according to the invention. FIG. 7B shows the dB values at different frequencies of the embodiment according to the invention shown in FIG. 7A.

In the sixth embodiment of the invention, as shown in FIG. 7A, the shapes of a first tuning bar 41d and a second tuning bar 42d of the broadband antenna 10f have widths that vary according to the gradients of the edges of the first tuning bar 41d and the second tuning bar 42d, respectively. The widths of the first tuning bar 41d and the second tuning bar 42d vary along the horizontal axis. As shown in FIG. 7B, the broadband antenna 10f also has broadband transmission capabilities according to the shape and is capable of adjusting the high or low frequency matching.

Therefore, according to the aforementioned embodiments, the invention is not limited to the shape of the tuning bar of the broadband antenna.

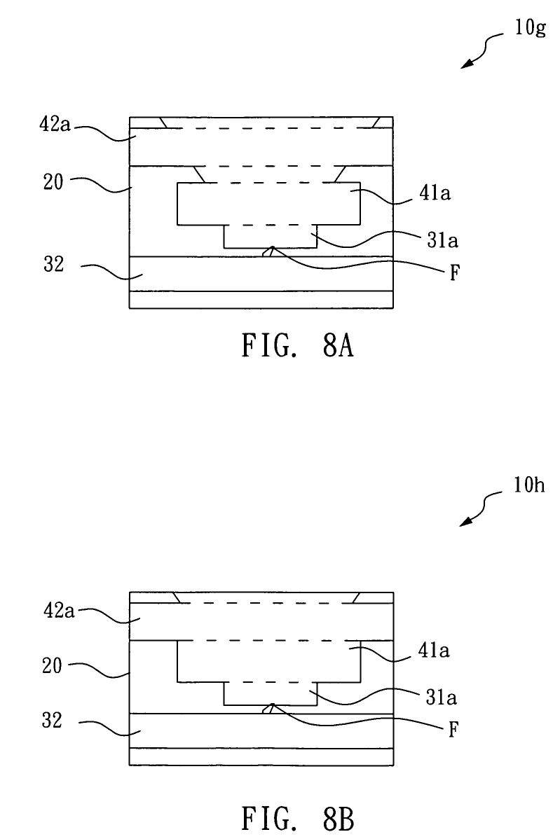

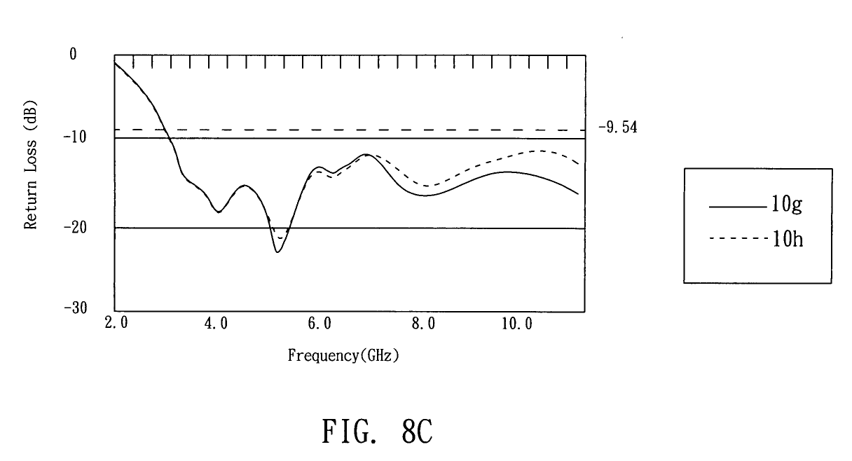

In addition, the positions of the first tuning bar 41a and the second tuning bar 42 can be adjusted. Please refer to FIG. 8A to FIG. 8C. FIG. 8A is a schematic drawing of a broadband antenna according to a seventh embodiment according to the invention. FIG. 8B is a schematic drawing of a broadband antenna according to an eighth embodiment according to the invention. FIG. 8C shows the dB values at different frequencies of the embodiments according to the invention shown in FIG. 8A and FIG. 8B.

As shown in FIG. 8A and FIG. 8B, the positions of the first tuning bar 41a and the second tuning bar 42a can be vertically adjusted. In contrast to the broadband antenna 10a, the distance between the first tuning bar 41a and the second tuning bar 42a of the broadband antenna 10g of the seventh embodiment according to the invention is shorter. The first tuning bar 41a and the second tuning bar 42a of the broadband antenna 10h according to the eighth embodiment of the invention contact each other directly. The operation bandwidths of the broadband antenna 10g and the broadband antenna 10h are shown in FIG. 8C. The broadband antenna 10g and the broadband antenna 10h also have broadband transmission capabilities and are capable of adjusting the high or low frequency matching.

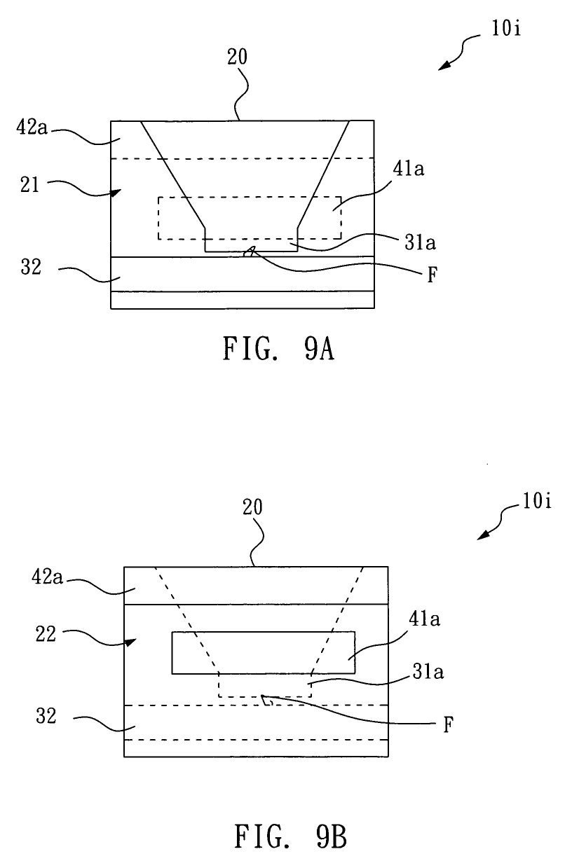

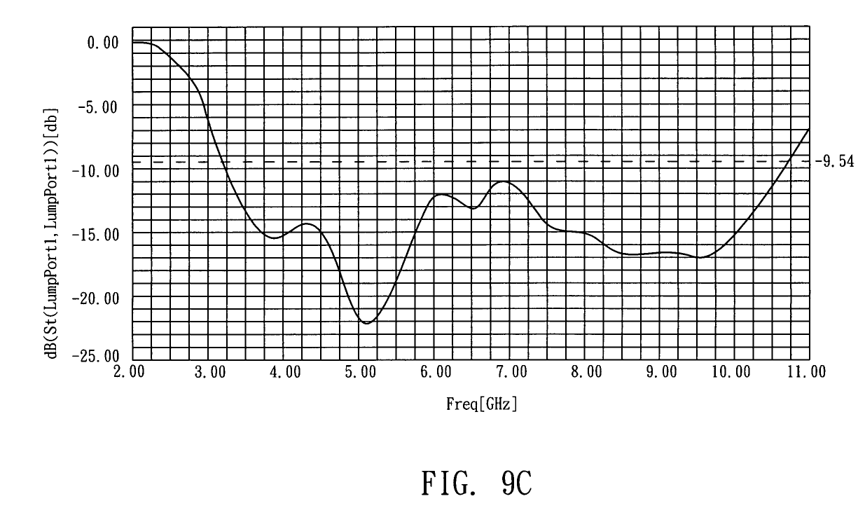

In addition, the invention is not limited to the first tuning bar 41a and the second tuning bar 42a being printed on the same plane of the base board 20 with the radiation area 3 la. Please refer to FIG. 9A to FIG. 9C. FIG. 9A is a front schematic drawing of a broadband antenna of a ninth embodiment according to the invention. FIG. 9B is a back schematic drawing of a broadband antenna of a ninth embodiment according to the invention. FIG. 9C shows the dB values at different frequencies of the embodiments according to the invention shown in FIG. 9A and FIG. 9B.

In the ninth embodiment according to the invention, the base board 20 of the broadband antenna 10i comprises a first surface 21 and a second surface 22. The radiation area 31a and the ground area 32 are printed on the first surface 21, and the first tuning bar 41a and the second tuning bar 42a are printed on the second surface 22. As shown in FIG. 9C, the broadband antenna 10i also has broadband transmission capabilities according to the shape and is capable of adjusting the high or low frequency matching by adjustment of the first tuning bar 41a and the second tuning bar 42a.

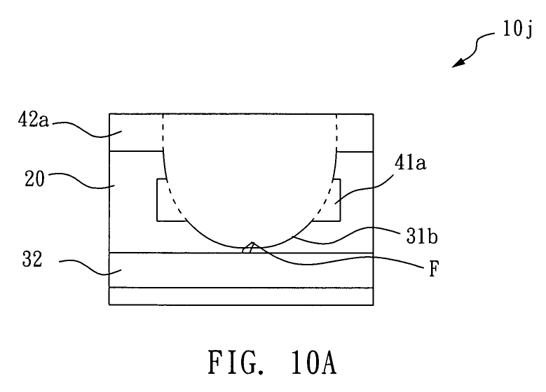

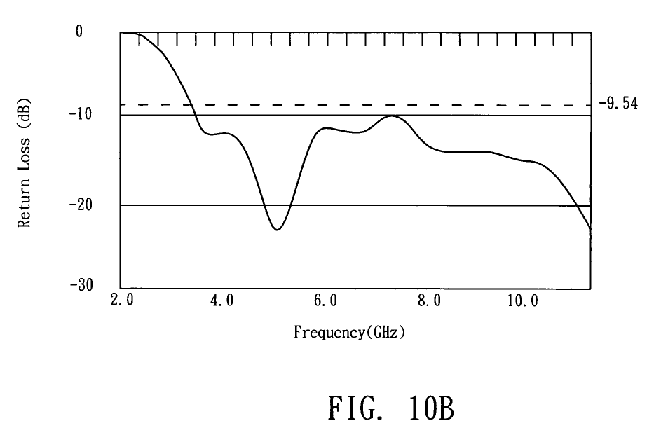

The shape of the radiation area 31a is not limited to the shape aforementioned. Please refer to FIG. 10A and FIG. 10B. FIG. 10A is a schematic drawing of a broadband antenna of a tenth embodiment according to the invention. FIG 10B shows the dB values at different frequencies of the embodiment according to the invention shown in FIG. 10A.

As shown in the FIG. 10A of the tenth embodiment according to the invention, the radiation area 31b of the broadband antenna 10j has curved edges. As shown in FIG. 10B, the broadband antenna 10j also has broadband transmission capabilities according to the shape of the radiation area 31b and is capable of adjusting the high or low frequency matching by adjustment of the first tuning bar 41a and the second tuning bar 42a.

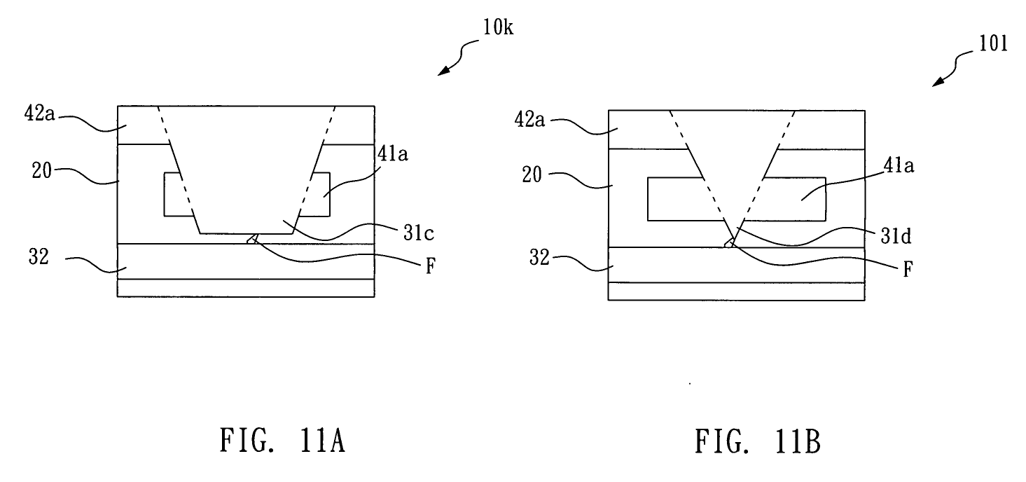

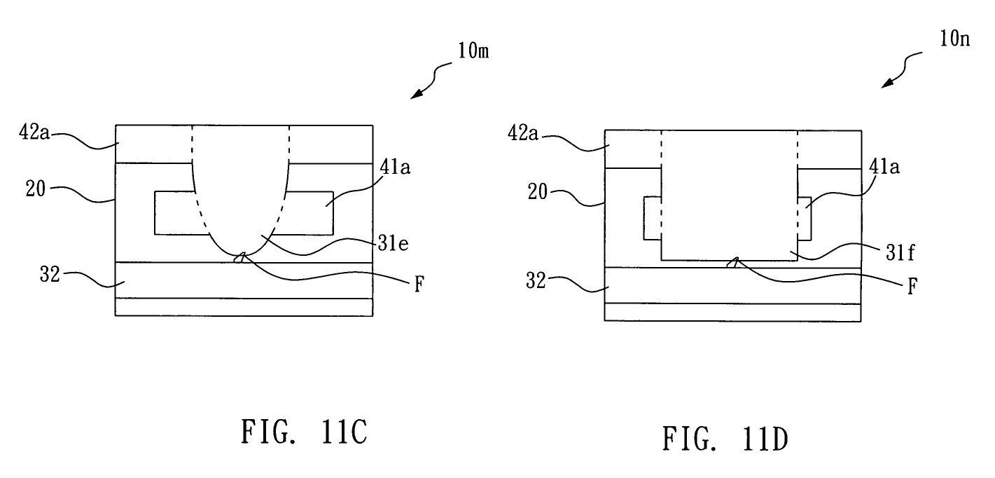

The shape of the radiation area also can be other shapes. Please refer to FIG. 11A to FIG. 11D. FIG. 11A is a schematic drawing of a broadband antenna of an eleventh embodiment according to the invention. FIG. 11B is a schematic drawing of a broadband antenna of a twelfth embodiment according to the invention. FIG. 11C is a schematic drawing of a broadband antenna of a thirteenth embodiment according to the invention. FIG. 11D is a schematic drawing of a broadband antenna of a fourteenth embodiment according to the invention.

The radiation area 31c of the broadband antenna 10k of the eleventh embodiment is trapezoidal in shape. The radiation area 31d of the broadband antenna 10l of the twelfth embodiment is triangular in shape. The radiation area 31e of the broadband antenna 10m of the thirteenth embodiment is cylindrical in shape. The radiation area 31f of the broadband antenna 10n of the fourteenth embodiment is rectangular in shape. The broadband antenna 10k to broadband antenna 10n also have broadband transmission capabilities with the first tuning bar 41a and the second tuning bar 42a. The bandwidth drawings of the broadband antenna 10k to the broadband antenna 10n of the eleventh embodiment to the fourteenth embodiment according to the invention are similar to that of the broadband antenna 10j, as shown in FIG 10B; therefore, further description is not provided.

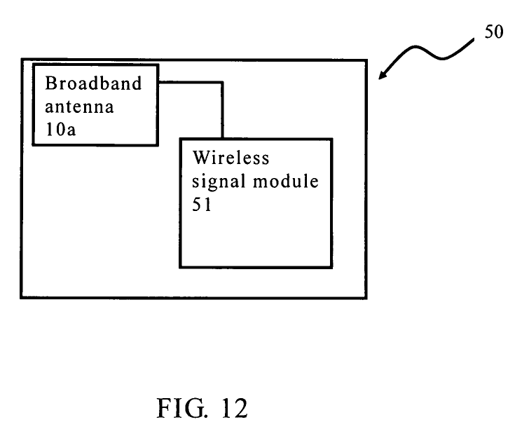

Please refer to FIG. 12. FIG. 12 is a functional block drawing of an electronic device according to an embodiment of the invention.

In one embodiment of the invention, an electronic device 50 can be a notebook computer or any other portable device with a small structural space. As shown in FIG. 12, the electronic device 50 comprises the broadband antenna 10a and a wireless signal module 51. The electronic device 50 uses RF cables to provide a feed to the broadband antenna 10a, and is connected to a wireless signal module 51, which processes signals from the broadband antenna 10a, such as transmitted or received signals. The electronic device 50 can thus use the broadband antenna 10a to transmit or receive wireless signals from or to other devices (not shown).

In addition, the electronic device 50 is not limited to comprise the broadband antenna 10a. Any antenna from the broadband antenna 10b to the broadband antenna 10n can be substituted for the broadband antenna 10a to transmit or receive wireless signals.

Although the present invention has been explained in relation to its preferred embodiment, it is to be understood that many other possible modifications and variations can be made without departing from the spirit and scope of the invention as hereinafter claimed.

What is claimed is:

1. A broadband antenna comprising:
a radiation area;
a ground area, used for grounding the broadband antenna;
a feeding point disposed on the radiation area and used for feeding a electrical signal;
a first tuning bar for adjusting a high frequency bandwidth of the broadband antenna; and
a second tuning bar for adjusting a low frequency bandwidth of the broadband antenna, wherein the length of the first tuning bar is less than the length of the second tuning bar.

2. The broadband antenna as claimed in claim 1, the broadband antenna further comprising a base board, on which the radiation area, the ground area, the first tuning bar, and the second tuning bar are printed.

3. The broadband antenna as claimed in claim 2, wherein the first tuning bar and the second tuning bar are printed on the same surface or different surfaces of the base board with the radiation area.

4. The broadband antenna as claimed in claim 1, wherein the first tuning bar and the second tuning bar are parallel to each other substantially.

5. The broadband antenna as claimed in claim 1, wherein the first tuning bar and the second tuning bar are not parallel to each other substantially.

6. The broadband antenna as claimed in claim 5, wherein the first tuning bar and the second tuning bar are in physical contact with each other.

7. The broadband antenna as claimed in claim 1, wherein the first tuning bar and the second tuning bar have widths that vary according to the gradients of the edges of the first tuning bar and the second tuning bar, respectively.

8. The broadband antenna as claimed in claim 1, wherein the ends of the first tuning bar and the ends of the second tuning bar are curved.

9. The broadband antenna as claimed in claim 1, wherein the radiation area has a width that varies according to the gradients of the edges of the radiation area.

10. The broadband antenna as claimed in claim 1, wherein the radiation area has curved edges or is cylindrical, trapezoidal, rectangular, or triangular in shape.

11. An electronic device having a broadband antenna and capable of wireless transmission, comprising:
a wireless signal module; and
a broadband antenna electrically connected to the wireless signal module, the broadband antenna comprising:
a radiation area;
a ground area, used for grounding the broadband antenna;
a feeding point disposed on the radiation area and used for feeding an electrical signal;
a first tuning bar for adjusting a high frequency bandwidth of the broadband antenna; and
a second tuning bar for adjusting a low frequency bandwidth of the broadband antenna, wherein the length of the first tuning bar is less than the length of the second tuning bar.

12. The electronic device having a broadband antenna as claimed in claim 11, the broadband antenna further comprising a base board, on which are printed the radiation area, the ground area, the first tuning bar, and the second tuning bar.

13. The electronic device having a broadband antenna as claimed in claim 12, wherein the first tuning bar and the second tuning bar are printed on the same surface or different surfaces of the base board with the radiation area.

14. The electronic device having a broadband antenna as claimed in claim 11, wherein the first tuning bar and the second tuning bar are parallel to each other substantially.

15. The electronic device having a broadband antenna as claimed in claim 11, wherein the first tuning bar and the second tuning bar are not parallel to each other substantially.

16. The electronic device having a broadband antenna as claimed in claim 15, wherein the first tuning bar and the second tuning bar are in physical contact with each other.

17. The electronic device having a broadband antenna as claimed in claim 11, wherein the first tuning bar and the second tuning bar have widths that vary according to the gradients of the edges of the first tuning bar and the second tuning bar, respectively.

18. The electronic device having a broadband antenna as claimed in claim 11, wherein the ends of the first tuning bar and the ends of the second tuning bar are curved.

19. The electronic device having a broadband antenna as claimed in claim 11, wherein the radiation area has a width that varies according to the gradients of the edges of the radiation area.

20. The electronic device having a broadband antenna as claimed in claim 17, wherein the radiation area has curved edges or is cylindrical, trapezoidal, rectangular, or triangular.
